(19) United States
(12) Patent Application Publication
(10) Pub. No.: US 2012/0200668 A1
(43) Pub. Date: Aug. 9, 2012

(54) VIDEO REPRODUCING APPARATUS AND VIDEO REPRODUCING METHOD

(76) Inventors: Yuki MARUYAMA, Osaka (JP); Kazuhito Kimura, Shiga (JP)

(21) Appl. No.: 13/365,637

(22) Filed: Feb. 3, 2012

(30) Foreign Application Priority Data
Feb. 7, 2011 (JP) 2011-023604
Dec. 6, 2011 (JP) 2011-266925

(51) Int. Cl. H04N 13/00

(52) U.S. Cl. 348/43; 348/E13.062

(57) ABSTRACT

A video reproducing apparatus includes: a decoding unit configured to decode the coded images for stereoscopic viewing, and output the decoded images for stereoscopic viewing and coding-related information which is used in the coding of the images for stereoscopic viewing and is related to compression distortion which occurs due to the coding; a quality determining unit configured to determine whether the decoded images for stereoscopic viewing should be output as a two-dimensional video or as a three-dimensional video, based on the coding-related information related to the compression distortion; and a screen generating unit configured to output the decoded images for stereoscopic viewing as the two-dimensional video or the three-dimensional video, according to the determination by the quality determining unit.

### CROSS REFERENCE TO RELATED APPLICATIONS

The present application is based on and claims priority of Japanese Patent Application No. 2011-023604 filed on Feb. 7, 2011, and is based on and claims priority of Japanese Patent Application No. 2011-266925 filed on Dec. 6, 2011. The entire disclosure of the above-identified applications, including the specifications, drawings and claims are incorporated herein by reference in its entirety.

### BACKGROUND OF THE INVENTION

(1) Field of the Invention

The present invention relates to a video reproducing apparatus and a video reproducing method for decoding a compressed stream recorded on a recording medium such as an optical disc, a magnet disc, a flash memory, or the like, and outputs the decoded stream as a three-dimensional (3D) video or a two-dimensional (2D) video.

(2) Description of the Related Art

Video coding generally reduces redundancy in the temporal direction and the spatial direction to compress the amount of information. The inter-frame predictive coding aiming to reduce the temporal redundancy detects motion amounts in units of a block by referring to forward and/or backward picture(s), and performs prediction based on the detected vectors (hereinafter referred to as motion compensation). In this way, the inter-frame predictive coding increases the prediction accuracy and coding efficiency.

An I-picture is a picture on which only an intra-predictive coding is performed (no inter-predictive coding is performed). The intra-predictive coding aims to reduce the spatial redundancy. A P-picture is a picture on which an inter-predictive coding is performed using a single reference picture. A B-picture is a picture on which an inter-predictive coding is performed using two reference pictures at maximum. Here, a picture is a term which represents a single screen.

Conventionally, various schemes have been proposed as schemes for coding a 3D video which corresponds to images for stereoscopic viewing. Here, a 3D video is of a video signal composed of image signals at a first view (hereinafter referred to as first-view image signals) and image signals at a second view (hereinafter referred to as second-view image signals). The first-view image signals and the second-view image signals correspond to image signals for the right eye and image signals for the left eye, respectively. On the other hand, a 2D video is of a video signal composed only of first-view image signals.

Examples of such schemes for coding a 3D video includes a scheme for coding first-view image signals according to the same scheme as the scheme for a 2D video, and coding second-view image signals by performing a motion compensation using, as a reference picture, the picture of a corresponding first-view image signal having the same time as that of the second-view image signal.

Another one of the examples is the scheme for reducing, to a half, each of first-view image signals and second-view image signals in the horizontal direction, arranges the reduced image signals horizontally, and codes the image signals according to the same scheme as the scheme for 2D video signals. In this case, supplemental information indicating that the video is a 3D video is added to the header information of the coded stream so that the coded stream of the 3D video is distinguished from the coded stream of a 2D video.

For example, Patent Reference 1 (Japanese Unexamined Patent Application Publication No. Hei 6 (1993)-113334) discloses a coding apparatus which calculates each of quantization values such that a small quantized value is set for an image (having a large disparity) located at a near point in the forward direction and a large quantized value is set for an image (having a small disparity) located at a distant point in the depth direction, with an aim to increase the coding efficiency and the visual characteristics.

It is known that a viewer of a 3D video suffers from paradoxical perception and has difficulty in the viewing of the 3D video in the case where the 3D video is a 3D video composed of right- and left-eye images having contents widely different from each other, specifically, in the case where the right- and left-eye images are different in the horizontal positions, angles, and sizes of the subjects. In addition, in the case of a 3D video having compression distortion due to compression coding, the right- and left-eye images which compose the 3D video suffer from mutually different kinds of coding distortion such as block noise and mosquito noise. For this reason, the viewer suffers from eye strain and a visually induced motion sickness more significantly when viewing a 3D video with such compression distortion due to such paradoxical perception, than in the case of viewing a video without such compression distortion.

A plurality of recording modes conforming to different recording rates is generally prepared for a Blu-ray (BD) recorder and an Advanced Video Codec High Definition (AVCHD) movie recorder. In this case, the recording time and the image quality is in a trade-off relationship. Thus, in the case where recording is performed in a recording mode for a low recording rate, the number of scenes which are quantized using a large quantization width is increased in order to reduce the data amount. For this reason, in the case where a 3D video is recorded in a recording mode for a low recording rate, there produced a problem that not only the image quality is reduced but also the 3D video is difficult to be viewed as a 3D video, compared to a case where the 3D video is recorded in a recording mode for a high recording rate.

### SUMMARY OF THE INVENTION

The present invention has been made to solve the aforementioned problem, with an aim to provide a video reproducing apparatus capable of reproducing coded images for stereoscopic viewing according to the characteristics of the images.

In order to solve the aforementioned problems, the video reproducing apparatus according to the present invention is a video reproducing apparatus which decodes coded images for stereoscopic viewing and outputs the decoded images for stereoscopic viewing, the video reproducing apparatus comprising: a decoding unit configured to decode the coded images for stereoscopic viewing, and output the decoded images for stereoscopic viewing and coding-related information which is used in the coding of the images for stereoscopic viewing and is related to compression distortion which occurs due to the coding; a quality determining unit configured to determine whether the decoded images for stereoscopic viewing should be output as a two-dimensional video or as a three-dimensional video, based on the coding-related information related to the compression distortion; and a screen generating unit configured to output the decoded images for stereoscopic viewing as the two-dimensional video or the three-dimensional video, according to the determination by the quality determining unit.

Here, compression distortion which occurs due to coding corresponds to the difference between images for stereoscopic viewing to be coded and decoded images for stereoscopic viewing obtained by decoding the coded images for stereoscopic viewing.

In this way, it is possible to determine whether the raw decoded images for stereoscopic viewing should be output as a three-dimensional (3D) video or a two-dimensional (2D) video, based on the coding-related information. In this way, it is possible to reproduce the decoded images according to the characteristics of the coded images for stereoscopic viewing. For example, in the case where the raw decoded images for stereoscopic viewing are difficult to be viewed, it is possible to reproduce the decoded images as a 2D video by forcibly switching to the 2D images. Therefore, it is possible to reduce the eye strain of the viewer.

Preferably, the coding-related information is one of a quantization width, a quantized matrix, a quantization parameter, a recording mode, and a recording rate, the one being used in the coding of the images for stereoscopic viewing.

Preferably, the quality determining unit the quality determining unit is configured to: determine that the decoded images for stereoscopic viewing should be output as the two-dimensional video, based on the coding-related information when the quality determining unit determines that the compression distortion is larger than a predetermined threshold; and determine that the decoded images for stereoscopic viewing should be output as the three-dimensional video based on the coding-related information when the quality determining unit determines that the compression distortion is equal to or smaller than the predetermined threshold.

This makes it possible to determine the compression distortion in the decoded images for stereoscopic viewing more accurately. In this way, it is possible to execute switching between the 2D images and the 3D images more appropriately even in the case of forcibly switching to the 2D images.

Preferably, the video reproducing apparatus further comprises a storing unit configured to store the coding-related information of the decoded images for stereoscopic viewing, wherein the quality determining unit is configured to output the decoded images for stereoscopic viewing as the two-dimensional video or the three-dimensional video, based on statistical information obtained from the coding-related information stored in the storing unit.

In this way, it is possible to determine whether the decoded images for stereoscopic viewing should be output as a 2D video or to output the same as a 3D video, based on items of the coding-related information stored in a predetermined past period of time. In this way, it is possible to execute switching between the 2D images and the 3D images more appropriately even in the case of forcibly switching to the 2D images.

Preferably, the video reproducing apparatus further comprises a receiving unit configured to receive a reproduction instruction for the coded images for stereoscopic viewing, wherein, upon receiving the reproduction instruction, the quality determining unit is configured to determine, before the output of the decoded images for stereoscopic viewing is started, whether the decoded images for stereoscopic viewing should be output as the two-dimensional video or as the three-dimensional video, based on the coding-related information, and the screen generating unit is configured to output the decoded images for stereoscopic viewing as the two-dimensional video or as the three-dimensional video according to the determination by the quality determining unit.

In this way, it is possible to determine and set whether the decoded images for stereoscopic viewing should be output as a 2D video or as a 3D video before the output of the decoded images is actually started. In this case, for example, there is no possibility that currently being reproduced decoded images for stereoscopic viewing are switched between 3D images and 2D images. Thus, the viewer can view the decoded images for stereoscopic viewing displayed according to one of the reproduction modes which is constant from start to end.

Preferably, the receiving unit is configured to receive the reproduction instruction on whether the coded images for stereoscopic viewing should be output as the two-dimensional video or as the three-dimensional video, and when the receiving unit receives the reproduction instruction indicating reproduction of the coded images for stereoscopic viewing as the three-dimensional video and the quality determining unit determines that the decoded images for stereoscopic viewing should be output as the two-dimensional video, the screen generating unit is configured to output a signal indicating output of the decoded images for stereoscopic viewing as the two-dimensional video before outputting the decoded images for stereoscopic viewing.

In this way, it is possible to notify the switching operation for the viewer when the decoded images for stereoscopic viewing are forcibly switched to the 2D images. In this way, the viewer can clearly recognize the operations by the recording apparatus.

Preferably, the quality determining unit is configured to detect a scene change, based on the decoded images for stereoscopic viewing, and determine whether the decoded images for stereoscopic viewing should be output as the two-dimensional video or as the three-dimensional video, based on the coding-related information upon detecting the scene change.

In this way, it is possible to switch between the 3D images and the 2D images with the timing of a scene change, without switching between the 3D images and the 2D images during the display of the same scene. Thus, the viewer can stably view the same scene of the decoded images for stereoscopic viewing according to the same reproduction mode.

Preferably, the video reproducing apparatus further includes an obtaining unit configured to obtain the coded images for stereoscopic viewing.

In this way, it is possible to obtain coded images for stereoscopic viewing even when the video reproducing apparatus does not include the coded images for stereoscopic viewing.

The present invention can be implemented or realized not only as the aforementioned video reproducing apparatus but also as a video reproducing method including the steps corresponding to the unique units of the video reproducing apparatus Furthermore, the present invention can be realized as a program causing a computer to execute the steps of the video reproducing method. Moreover, the program can be recorded onto a recording medium such as a computer-readable CD-ROM, or can be realized as information, data, and/or a signal representing the program. Naturally, the program, information, data, and/or signal may be distributed via communication networks such as the Internet.

The video reproducing apparatus according to the present invention reproduces a compressed stream based on a condition which is set when the compressed stream is coded and recorded, and thus can reproduce the compressed stream in the manner suitable for the characteristics of the compressed stream.

### BRIEF DESCRIPTION OF THE DRAWINGS

These and other objects, advantages and features of the invention will become apparent from the following description thereof taken in conjunction with the accompanying drawings that illustrate a specific embodiment of the present invention. In the Drawings:

FIG. 1 is a block diagram showing an overall structure of a recording apparatus which is a video reproducing apparatus according to an embodiment of the present invention;

FIG. 2 is a functional block diagram of the signal processing unit according to the embodiment;

FIG. 3 is a flowchart showing exemplary processes executed when the signal processing unit according to the embodiment executes reproduction.

FIG. 4 is a diagram showing an example of a reproduction list in the embodiment;

FIG. 5 is a flowchart showing exemplary processes executed when the quality determining unit according to the embodiment executes reproduction;

FIG. 6 is an illustration of a reproduction screen on which an alert message is displayed according to the embodiment;

FIG. 7 is an illustration of a reproduction screen on which an alert message is displayed according to the embodiment;

FIG. 8 is an illustration of a reproduction screen on which an alert message is displayed according to the embodiment;

FIG. 9 is a flowchart showing exemplary processes executed when the signal processing unit according to a variation of the embodiment executes reproduction;

FIG. 10 is a flowchart showing exemplary processes executed when the quality determining unit according to the variation of the embodiment executes reproduction; and

FIG. 11 is an illustration of a screen on which an alert message is displayed according to the variation of the embodiment.

### DESCRIPTION OF THE PREFERRED EMBODIMENT

### Recording Apparatus

Hereinafter, an embodiment of the present invention is described with reference to the drawings.

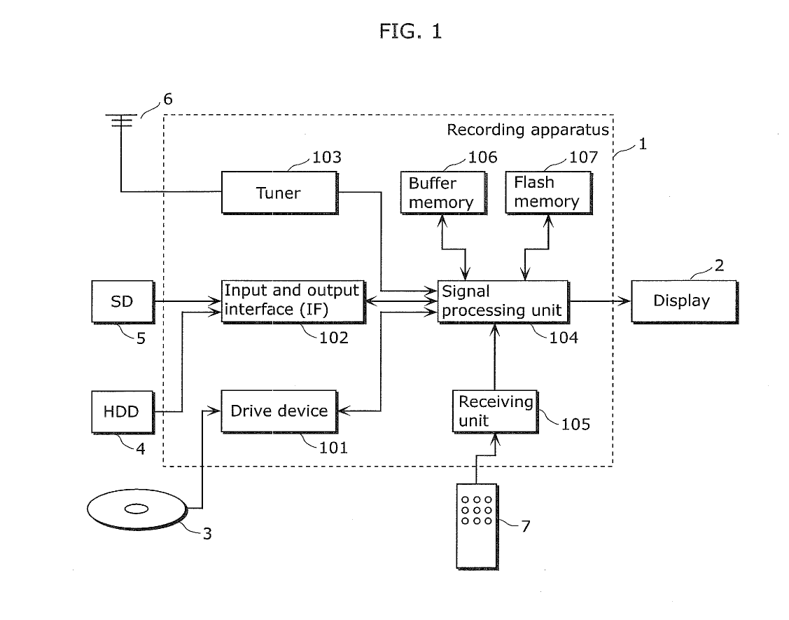

FIG. 1 is a block diagram showing an overall structure of a recording apparatus 1 which is a video reproducing apparatus according to the embodiment of the present invention. As shown in FIG. 1, the recording apparatus 1 is connected to a display 2, a BD disc 3, an HDD apparatus 4, an SD card 5, and an antenna 6. The recording apparatus 1 receives, as an input, image signals that are output from the BD disc 3, the HDD apparatus 4, the SD card 5, and the antenna 6. The recording apparatus 1 processes these image signals and displays the image signals as an actual video on the display 2.

In addition, the recording apparatus 1 receives an operation signal that is output from a remote controller operated by a user.

The display 2 displays, as a display screen, the display signal output from the recording apparatus 1. The display 2 can be implemented in the form of a liquid display, for example. Preferably, the display 2 is a display device capable of displaying a 3D video signal. The display 2 is not limited to such a liquid crystal display, and can be implemented in the form of a PDP, for example.

The HDD apparatus 4 is a recording apparatus which stores image signals. The HDD apparatus 4 can be implemented as an exterior-type hard disk apparatus, for example.

The SD card 5 is a recording medium which stores image signals. The SD card 5 can be implemented as a semiconductor recording device such as an SD card and a memory card.

The antenna 6 receives image signals transmitted from outside.

The remote controller 7 is an operation device which receives operations from the user. The remote controller 7 includes a plurality of buttons that are pressed for operations. With the buttons pressed, the remote controller 7 generates an operation signal. The remote controller 7 transmits the generated operation signal to the recording apparatus 1 wirelessly. In this way, the recording apparatus 1 can detect the user operation.

### Detailed Structure of Recording Apparatus

Hereinafter, the structure of the recording apparatus 1 is described in detail with reference to the drawings.

Specifically, as shown in FIG. 1, the recording apparatus 1 includes a drive device 101, an input and output interface (IF) 102, a tuner 103, a signal processing unit 104, a receiving unit 105, a buffer memory 106, and a flash memory 107.

The drive device 101 includes a disc tray, and is intended to read out the image signals from the BD disc 3 stored on the disc tray. In addition, when the image signals are input from the signal processing unit 104, the drive device 101 writes the image signals onto the BD disc 3 stored on the disc tray.

The input and output IF unit 102 is an interface which enables connection with the HDD apparatus 4 and the SD card 5. The input and output IF unit 102 enables exchange of a control signal, image signals, and the like with the signal processing unit 104. The input and output IF unit 102 transmits an input stream input from the HDD apparatus 4 or the SD card 5 to the signal processing unit 104. In addition, the input and output IF unit 102 transmits the coded stream input from the signal processing unit 104 or a non-compressed video stream to the HDD apparatus 4 or the SD card 5. For example, the input and output IF unit 102 is implemented as an HDMI connector, an SD card slot, a USB connector, or the like.

The tuner 103 receives a broadcast wave received by an antenna 6. The tuner 103 transmits, to the signal processing unit 104, a video signal having a specific frequency specified by the signal processing unit 104. In this way, the signal processing unit 104 processes the video signal having the specific frequency included in the broadcast wave, and displays it on the display 2.

Here, the drive device 101, the input and output IF unit 102, and the tuner 103 in this embodiment are capable of obtaining at least images for stereoscopic viewing. The drive device 101, the input and output IF unit 102, and the tuner 103 output the obtained images for stereoscopic viewing to the signal processing unit 104. Hereinafter, the signal which is output to the signal processing unit 104 is referred to as an input stream. This input stream is such images for stereoscopic viewing or a 2D video.

Here, the images for stereoscopic viewing correspond to a video composed of a pair of images which are used in stereoscopic viewing using the display 2. For example, the images for stereoscopic viewing may correspond to a video composed of a first-view video signal and a second-view video signal. This video for stereoscopic viewing may be a stream coded based on Multi View Coding (MVC). Alternatively, the images for stereoscopic viewing may correspond to a video in which the first-view images and the second-view images are arranged according to a side-by-side scheme or a top-and-bottom scheme.

The signal processing unit 104 controls the respective units of the recording apparatus 1. Furthermore, the signal processing unit 104 codes and decodes the image signals which are output from the input and output IF unit 102, the drive device 101, and the tuner 103. The signal processing unit 104 decodes and reproduces the input stream compressed and coded using a coding standard such as H. 264/AVC and MPEG-2. Furthermore, the signal processing unit 104 codes and records the input stream according to, for example, the High Efficiency Video Coding (HEVC) Standard that is the next-generation image coding standardized standard and the coding standard such as H.264/AVC and MPEG-2. Here, the signal processing unit 104 is not limited to the one according to the aforementioned compression format, and may use another compression format.

Furthermore, the signal processing unit 104 sets the following two modes: a reproduction mode for reproducing an input stream as a two-dimensional (2D) video (hereinafter referred to as a two-dimensional mode); and a reproduction mode for reproducing an input stream as a three-dimensional (3D) video (hereinafter referred to as a three-dimensional mode).

The signal processing unit 104 may be configured to set the two-dimensional mode or the three-dimensional mode based on an operation signal from the remote controller 7. Furthermore, the signal processing unit 104 may be configured to set one of the modes based on meta information included in the input stream such as header information and program information whichever is obtainable in the decoding of the input stream.

Furthermore, the signal processing unit 104 controls a recoding mode which is used to record the input stream onto the BD disc 3, the HDD apparatus 4, or the SD card 5. The recording mode is a recording rate which is set as a target value when transforming the input stream into a coded stream. Examples of possible recording modes includes: a recording mode for directly recording the input stream without coding the input stream, and a recording mode for recording which achieves a recording rate of 8 Mbps. The signal processing unit 104 includes a plurality of selectable recording modes. For example, the signal processing unit 104 can be configured to select recording modes for achieving 16 Mbps, 8 Mbps, 3 Mbps, and 1 Mbps.

Furthermore, the signal processing unit 104 performs various kinds of video processing on the input stream, and outputs, onto the display 2, the display signal which can be displayed onto the display 2. In addition, the signal processing unit 104 generates the operation screen for the recording apparatus 1, and outputs the operation screen onto the display 2.

The signal processing unit 104 may be implemented in the form of a micro computer, or a hard-wired logic circuit.

The receiving unit 105 is intended to receive an operation signal from the remote controller 7 and transmit the operation signal to the signal processing unit 104. The receiving unit 105 can be implemented as an infrared sensor, for example.

The buffer memory 106 is used as a work memory when the signal processing unit 104 performs signal processing. The buffer memory 106 can be implemented in the form of a DRAM, for example.

The flash memory 107 is intended to store a program and/or the like which are/is executed by the signal processing unit 104.

### Signal Processing Unit 104

Next, the structure of the signal processing unit 104 is described in detail with reference to the drawings.

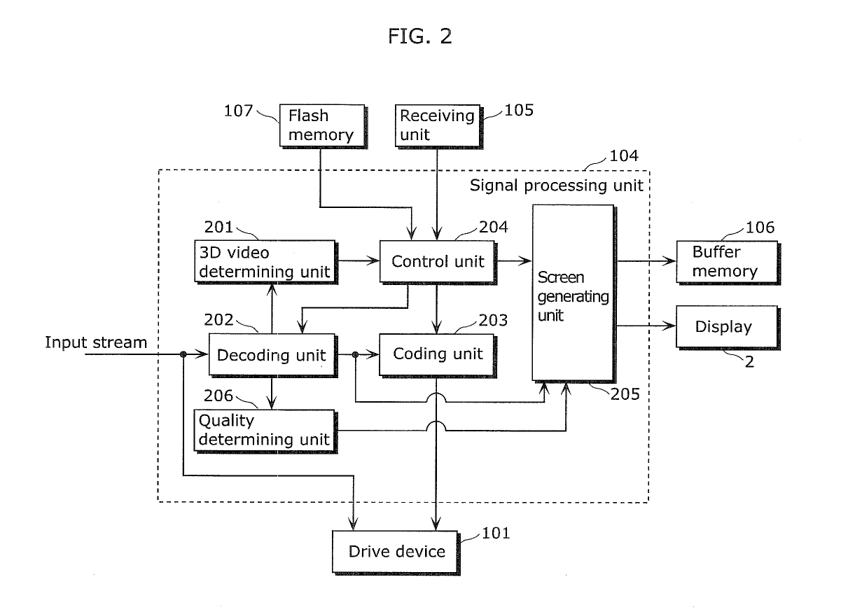

FIG. 2 is a functional block diagram of the signal processing unit 104 according to this embodiment.

As shown in FIG. 2, the signal processing unit 104 includes a three-dimensional (3D) video determining unit 201, a decoding unit 202, a coding unit 203, a control unit 204, a screen generating unit 205, and a quality determining unit 206.

The 3D video determining unit 201 determines whether an input stream is a 3D video or a 2D video. The 3D video determining unit 201 notifies the result of the determination to the control unit 204. The determining method by the 3D video determining unit 201 is described later in detail.

The decoding unit 202 decodes the input stream based on control information from the control unit 204, and outputs coding-related information related to compression distortion. Here, examples of the coding-related information include at least: header information such as quantization widths, quantized matrices, quantized parameters (Qₚ values) which are applied in the coding of the input stream and are obtainable when decoding the input stream; and information such as recording modes, the amount of data, a recording time. Here, in the case where the input stream is compressed and coded according to the H.264/AVC Coding Standard, the quantization widths are calculated from the quantized parameters and the quantized matrices.

The decoding unit 202 outputs the coding-related information obtained by decoding to the 3D video determining unit 201 and the quality determining unit 206.

The coding unit 203 compresses and codes the decoded images output by the decoding unit 202 based on the control information from the control unit 204. For example, in the case where the control information from the control unit 204 shows a two-dimensional mode, the coding unit 203 codes the input stream as a 2D video. On the other hand, in the case where the control information from the control unit 204 shows a three-dimensional mode, the coding unit 203 codes the input stream as a 3D video. In this case, the coding unit 203 performs the coding according to the recording mode notified from the control unit 204. Furthermore, the coding unit 203 records the obtained coded stream onto any one of the HDD apparatus 4, the BD disc 3, and the SD card 5. Here, the user can select the one of the HDD apparatus 4, the BD disc 3, and the SD card 5 to which the coded stream is recorded, using the remote controller 7. Alternatively, in the case where the coding unit 203 receives the recording condition for recording the decoded images without coding, the coding unit 203 records the raw decoded images onto one of the HDD apparatus 4, the BD disc 3, and the SD card 5. Here, when the coded stream is recorded, management information such as the recording modes, the amount of data, the reproduction time, the program information of the coded stream are also recorded together. Here, FIG. 2 discloses the signal processing unit in which the coding unit 203 outputs a coded stream to the drive device 101.

The control unit 204 controls the overall operations of the signal processing unit 104. The control unit 204 sets the two-dimensional mode or the three-dimensional mode, based on the notification from the 3D video determining unit 201. For example, the control unit 204 sets the two-dimensional mode, when the notification from the 3D video determining unit 201 indicates that the input stream is a 2D video. On the other hand, the control unit 204 sets the three-dimensional mode, when the notification from the 3D video determining unit 201 indicates that the input stream is a 3D video. When the two-dimensional mode or the three-dimensional mode is set, the control unit 204 notifies the control information indicating the set mode to the coding unit 203 and the screen generating unit 205. Furthermore, in the case where the control unit 204 receives a notification of the recording mode specified by the user from the receiving unit 105, the control unit 204 outputs the notification to the coding unit 203.

The screen generating unit 205 outputs the input stream as a three-dimensional video or a two-dimensional video, according to the determination by the quality determining unit 206. More specifically, the screen generating unit 205 generates a screen which is displayed onto the display 2, based on the control information from the control unit 204 and the control information from the quality determining unit 206. For example, the screen generating unit 205 generates and outputs a two-dimensional screen when the control information indicating the two-dimensional mode is notified from the control unit 204 and the control information for reproduction according to the reproduction mode from the control unit 204 is notified from the quality determining unit 206. Furthermore, the screen generating unit 205 outputs a two-dimensional screen when the control information indicating the three-dimensional mode is notified from the control unit 204 and the control information for forcibly outputting a 2D video irrespective of the reproduction mode from the control unit 204 is notified from the quality determining unit 206. In other words, the screen generating unit 205 prioritizes the control signal from the quality determining unit 206 and forcibly switches the modes to the reproduction mode for forcible reproduction although the user or the like specifies output of the input stream as a three-dimensional video.

The quality determining unit 206 determines whether the input stream should be output as a two-dimensional video or as a three-dimensional video, based on the coding-related information. More specifically, the quality determining unit 206 generates a control signal for defining whether the screen generating unit 205 should reproduce a decoded video based on a control signal from the control unit 204 or the screen generating unit 205 should forcibly reproduce a decoded video as a 2D video, based on the coding-related information output by the decoding unit 202. The quality determining unit 206 outputs the generated control signal to the screen generating unit 205.

In other words, the quality determining unit 206 determines whether or not the decoded images output by the decoding unit 202 are images which are easy to be viewed as a 3D video, based on the coding-related information. In the case where the decoded images are easy to be viewed as a 3D video, the quality determining unit 206 outputs, to the screen generating unit 205, control information indicating the reproduction of the decoded images, based on the control signal from the control unit 204. On the other hand, in the case where the decoded images are difficult to be viewed as a 3D video, the quality determining unit 206 outputs, to the screen generating unit 205, control information indicating the forcible reproduction of the decoded images as a 2D video. The operations by the quality determining unit 206 are described later in detail.

The aforementioned control information may be flag information. In addition, the control information may be command information which is specially prepared. To sum up, any information may be used as long as the information can be used to determine whether the screen generating unit 205 should reproduce the decoded images based on the control signal from the control unit 204 or the screen generating unit 205 should forcibly reproduce the decoded images as a 2D video.

### Operation Flow

Next, operations for reproducing an input stream by the signal processing unit 104 are described with reference to the drawings. For the convenience of explanation, it is assumed that the signal processing unit 104 receives, as an input, an input stream compressed and coded according to the H.264/AVC Coding Standard.

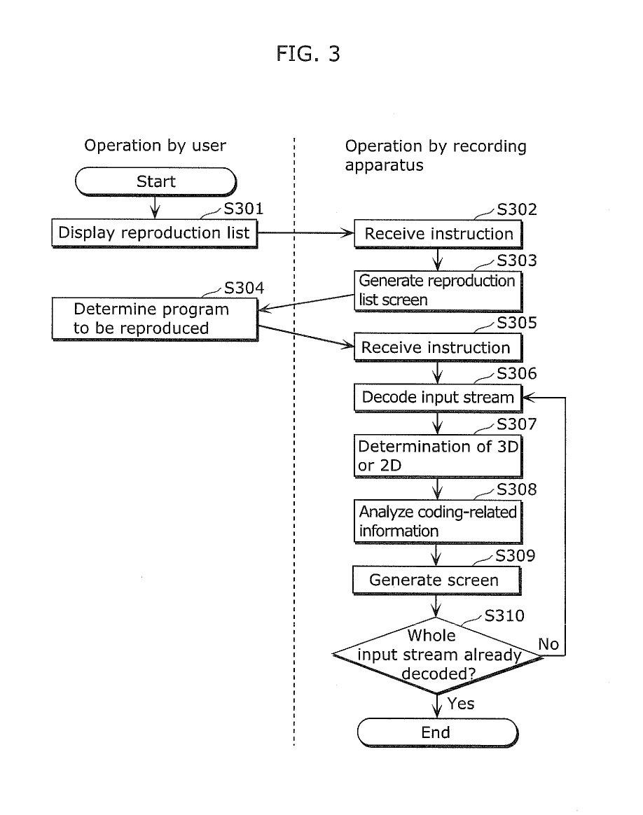

FIG. 3 is a flowchart showing exemplary processes executed when the signal processing unit 104 according to this embodiment executes reproduction. Here, Steps S301 and S304 are processing steps executed by the user using the remote controller 7, and Step S302, S303, S305, S306, S307, S308, S309, and S310 are processing steps executed by the recoding apparatus 1.

### Reproduction Operation Flow

The remote controller 7 receives a user operation, and transmits, to the receiving unit 105, an instruction for displaying a reproduction list of recorded programs (hereinafter, the instruction is referred to as a reproduction list display instruction) (S301). At this time, the user presses a “Reproduction list” button on the remote controller 7.

Next, the screen generating unit 205 receives the reproduction list display instruction from the remote controller 7 via the receiving unit 105 and the control unit 204 (S302).

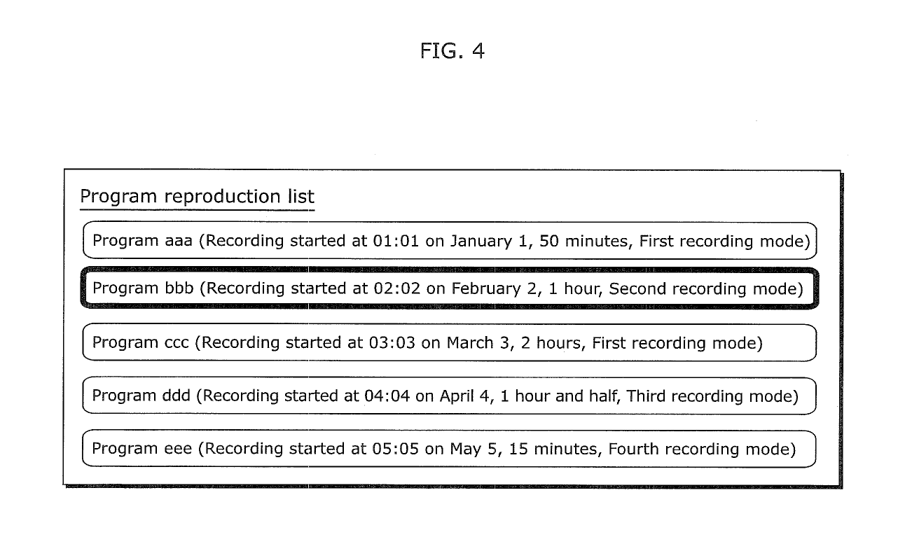

Next, the screen generating unit 205 generates the screen for the reproduction list according to the received reproduction list display instruction (S303). The reproduction list displayed on the display 2 at this time is, for example, a reproduction list as shown in FIG. 4.

Next, the user determines to reproduce one of the recorded programs while looking at the screen on the display 2 generated by the screen generating unit 205. The user specifies the program to be reproduced by moving a cursor on the screen using the remote controller 7. At this time, the user presses a Determination button on the remote controller 7. When the Determination button is pressed, the remote controller 7 transmits the selection instruction to the receiving unit 105 (S304).

The decoding unit 202 and the screen generating unit 205 receive the selection instruction via the receiving unit 105 and the control unit 204 (S305).

Next, the decoding unit 202 receives the selection instruction from the control unit 204, and sequentially compresses and decodes the input stream. Then, the decoding unit 202 outputs the generated decoded images to the screen generating unit 205, and outputs the coding-related information to the 3D video determining unit 201 and the quality determining unit 206 (S306). In this embodiment, the decoding unit 202 does not compress and decode the whole input stream once, but generates decoded image parts required to output the screen onto the display 2 and makes a transition to the next step S307.

Next, the 3D video determining unit 201 analyzes the header information of the input stream received from the decoding unit 202, and determines whether the decoded images correspond to a 3D video or a 2D video (S307).

Next, the quality determining unit 206 analyzes the coding-related information output by the decoding unit 202, and determines whether or not the decoded images can be viewed as a 3D video which is easy to be viewed stereoscopically (S308). In the case where the quality determining unit 206 determines that the decoded images can be viewed as a 3D video, the quality determining unit 206 turns off a modification flag and outputs the turned-off modification flag to the screen generating unit 205. In the case where the quality determining unit 206 determines that the decoded images can not be viewed as a 3D video, the quality determining unit 206 turns on a modification flag and outputs the turned-on modification flag to the screen generating unit 205. Step S308 is described in detail later.

Next, the screen generating unit 205 generates an output screen, based on the information from the control unit 204 and the modification flag obtained from the quality determining unit 206 (S309). Step S309 is described in detail later.

Next, the control unit 204 determines whether or not the whole input stream is already decoded (S310). In the case where the whole input stream is already decoded (Yes in Step S310), the control unit 204 completes the reproduction operations. In the case where the whole input stream is not yet decoded (No in Step S310), the control unit 204 makes a transition to Step S306.

### Operations by Quality Determining Unit 206

Next, exemplary processes executed in Step S308 are described in detail with reference to the drawings.

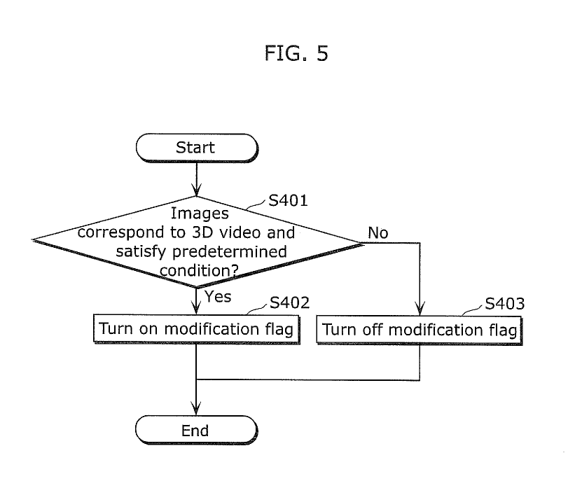

FIG. 5 is a flowchart indicating exemplary processes that the quality determining unit 206 performs to determine whether or not decoded images can be viewed as a 3D video which is easy to be viewed stereoscopically.

First, the quality determining unit 206 analyzes the coding-related information, and determines whether or not the decoded images correspond to a 3D video and satisfy a predetermined condition (S401).

When determining that the decoded images correspond to a 3D video and satisfy the predetermined condition (Yes in Step S401), the quality determining unit 206 turns on the modification flag and outputs the turned-on modification flag to the screen generating unit 205 (S402).

On the other hand, when determining that the decoded images correspond to a 3D video and does not satisfy the predetermined condition (No in Step S401), the quality determining unit 206 turns off the modification flag and outputs the turned-off modification flag to the screen generating unit 205 (S403).

Here, whether the decoded images correspond to a 3D video or a 2D video is determined by analyzing the header information of the input stream.

For example, a quantization width used in the coding of the input stream is used as the predetermined condition. More specifically, whether or not the quantization width is equal to or larger than a predetermined first threshold is determined as the predetermined condition. In other words, when the quantization width is equal to or larger than the predetermined first threshold, the images coded using the quantization width are determined to correspond to a video in which a large amount of quantization distortion occurs.

The quantization width used here is, for example, the quantization width of a current frame to be decoded. In addition, for example, it is possible to hold the quantization width of an I-picture which is decoded immediately before the current picture, and make a determination based on the quantization width. Alternatively, it is possible to make a determination by performing statistical processing on the quantization width of at least one of decoded frames. Examples of such statistical processing include a method using an average value, a histogram, or the like. Alternatively, it is possible to make a determination by separately performing statistical processing on pictures according to the picture types such as I-picture, P-picture, and B-picture. Alternatively, it is possible to hold values calculated according to any one of the aforementioned methods, and update the quantization width at an interval of several minutes. Alternatively, it is possible to determine whether or not the quantization width of each frame is equal to or grater than the first threshold, and determine that the predetermined condition is satisfied when the quantization width is kept equal to or grater than the first threshold for a predetermined period of time or more. Here, as described above, when the input stream is compressed and coded according to the H.264/AVC Coding Standard, the quantization widths are calculated based on the quantized parameters (Qp values) and the quantized matrices. Thus, it is possible to use the quantized parameters or the quantized matrices as the predetermined conditions.

Although the quantization width of the current frame to be decoded is used as the predetermined condition above, it is also possible to use the quantization width of a frame of one of the right images and left images of a 3D video, or to use the quantization widths of both the right images and left images.

Alternatively, it is possible to use the recording rate of the input stream as the predetermined condition. More specifically, whether or not the recording rate of the input stream is equal to or smaller than a predetermined second threshold is determined to be the predetermined condition. Here, the recording rate is the average bit rate of the input stream, and is calculated based on the data amount and the recording time of the input stream. Alternatively, it is possible to determine the recording rate based on the recording mode.

Alternatively, in the case where the input stream is input in a real-time encoding, it is possible to use the remaining amount of the decoding picture buffer (DPB) which is a buffer for use in decoding. The capacity of the decoding picture buffer is determined in coding, and the coding is performed so as to prevent the decoding picture buffer from overflowing. For this reason, in the case where the remaining amount of the decoding picture buffer becomes small, the data amount may be reduced by increasing the quantization width, for example. Thus, it is possible to determine that a large amount of quantization distortion occurs in such a case. More specifically, whether or not the remaining amount of the decoding picture buffer is equal to or smaller than a predetermined third threshold is determined to be the predetermined condition.

Alternatively, it is possible to use the bandwidth of the network as the predetermined condition. In the case where the bandwidth of the network is small, the data amount may be reduced. Thus, it is possible to determine that a large amount of quantization distortion occurs in such a case. More specifically, whether or not the bandwidth of the network is equal to or larger than a predetermined fourth threshold is determined as the predetermined condition.

### Operations by Screen Generating Unit 205

Next, operations by the screen generating unit 205 are described with reference to the drawings.

In the case where a turned-off modification flag is output by the quality determining unit 206, the screen generating unit 205 outputs decoded images output from the decoding unit 202, based on a control signal output by the control unit 204.

In the case where a turned-on modification flag is output, the screen generating unit 205 replaces second-view images which compose a 3D video together with first-view images with the data of the first-view images. This operation makes the second-view images identical to the first-view images. For this reason, the images perceived as a 2D video by a user are output although the mode is the three-dimensional mode. At this time, since the mode is the three-dimensional mode, the display unit which outputs the output images performs the display operation assuming that the input image signals correspond to a 3D video signal.

In the case where the turned-on modification flag is output, the screen generating unit 205 may switch from the three-dimensional mode to the two-dimensional mode and output the decoded images.

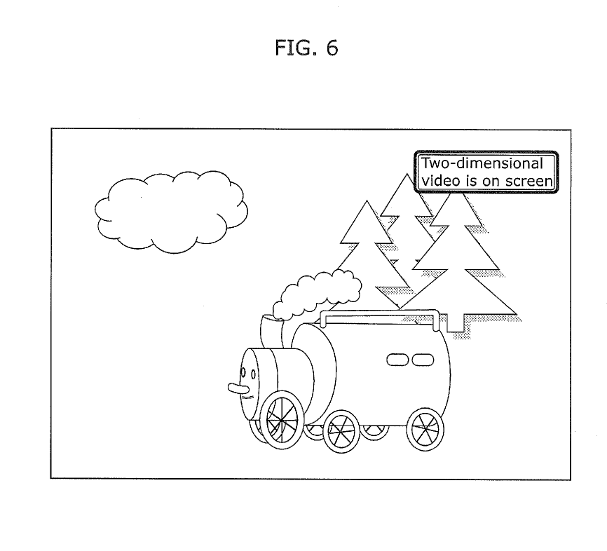

Furthermore, as shown in FIG. 6, for example, in the case where the turned-on modification flag is output, the screen generating unit 205 may add a message indicating that the input signal is displayed as a 2D video to the decoded images and outputs the decoded images with the message.

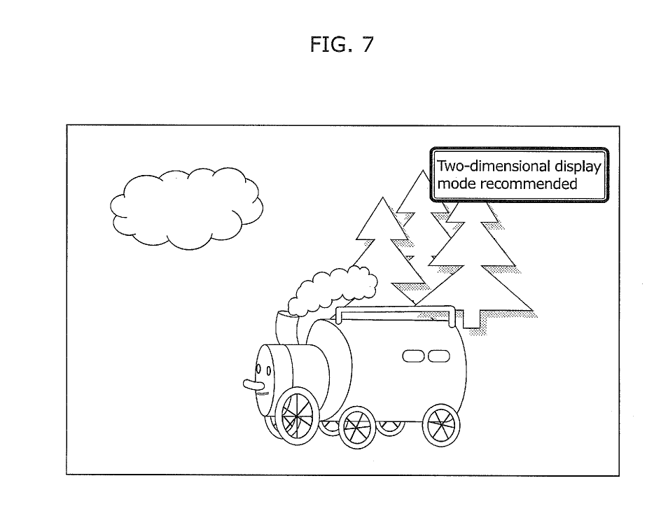

Alternatively, as shown in FIG. 7, for example, in the case where the turned-on modification flag is output, the screen generating unit 205 may add, to the decoded images, a message recommending that the input signal be displayed according to the two-dimensional mode and outputs the decoded images with the message when displaying the input signals as a 3D video.

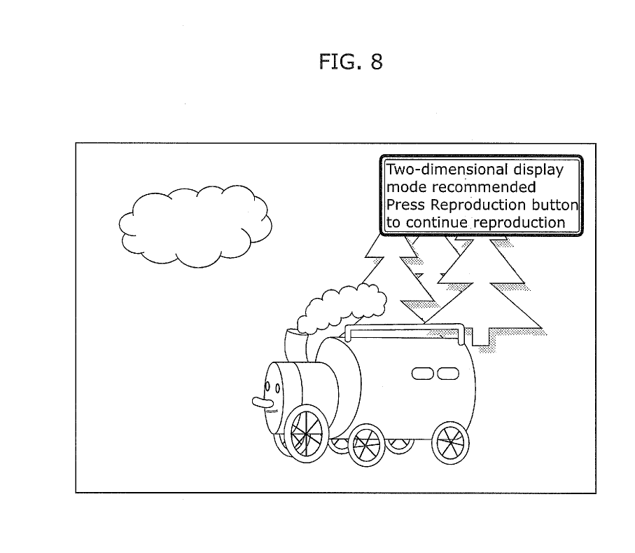

Furthermore, in the case where the turned-on modification flag is output, the screen generating unit 205 may temporarily stop the reproduction of the input signals as the 3D video, and may add, to the decoded images, a message such as a message indicating that “Display according to two-dimensional mode is recommended. Press reproduction button to continue reproduction.” As shown in FIG. 8, and outputs the decoded images with the message when displaying the input signals as a 3D video. In this case, a press of the Reproduction button can restart the reproduction of the 3D video.

Furthermore, in the case where the turned-on modification flag is output, the screen generating unit 205 may stop the reproduction of the input signals as the 3D video.

As described above, the video reproducing apparatus according to this embodiment determines whether or not decoded images can be viewed as a 3D video which is easy to be viewed stereoscopically, based on (i) header information, (ii) coding-related information such as the recording mode, the data amount, and the recording time whichever is obtainable when decoding the input stream. In the case where the video reproducing apparatus determines that a safe viewing cannot be achieved, the video reproducing apparatus modifies the decoded images to be viewed as a 2D video. Alternatively, a message recommending the display of the input signal as a 2D video is displayed on the screen. For this reason, it is possible to reduce eye strain and motion sickness induced visually when a 3D video with compression distortion is viewed.

### Variation of Embodiment

This variation of the embodiment is intended to obtain coding-related information of an input stream before reproducing decoded images, and determine whether or not the decoded images can be viewed as a 3D video which is easy to be viewed stereoscopically, based on the coding-related information. Hereinafter, the recording apparatus 1 according to this variation is described with reference to the drawings.

The recording apparatus 1 according to this variation has the same structure as that of the embodiment, and thus the same detailed descriptions are not repeated here.

Next, operations for reproducing an input stream by the signal processing unit 104 are described with reference to the drawings.

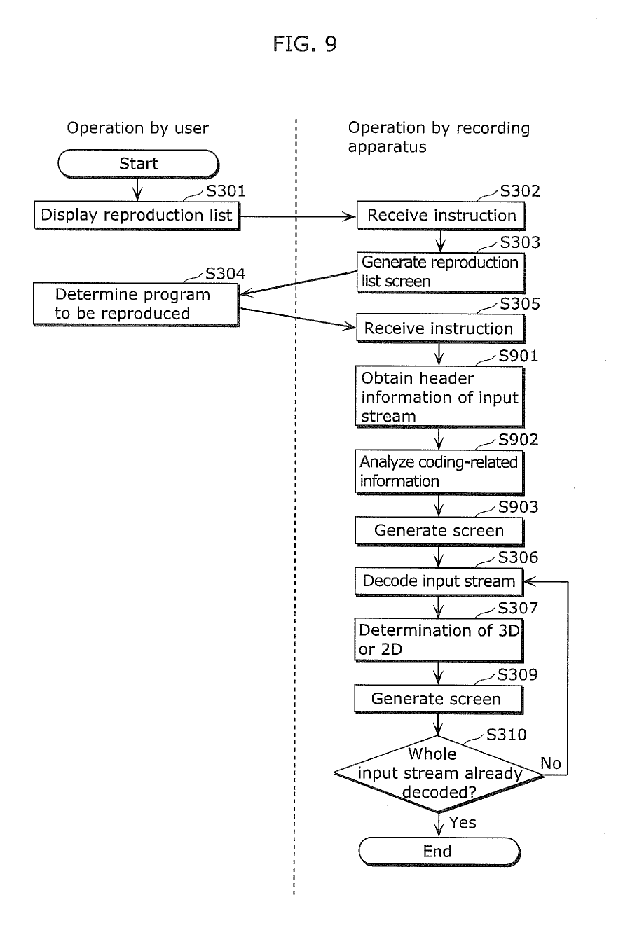

FIG. 9 is a flowchart showing exemplary processes executed when the signal processing unit 104 according to this variation executes reproduction.

Here, operations in Steps S301, S302, S303, S304, S305, S306, S307, S309, and S310 are the same as those in the embodiment. Thus, the same reference signs are assigned to the same steps, and the same detailed descriptions are not repeated here.

First, processes in Steps S301, S302, S303, S304, and S305 are executed.

Next, the decoding unit 202 receives a selection instruction from a control unit 204, analyzes the input stream, and outputs coding-related information to the 3D video determining unit 201 and the quality determining unit 206 (S901). Here, the decoded images are not output. In other words, only the coding-related information is extracted and output prior to the images. At this time, it is possible to analyze the whole input stream, or to analyze only the data corresponding to the several pictures when counted from the top of the input stream. Furthermore, for example, it is possible to obtain only the coding-related information of I-pictures. In this way, it is possible to determine, for each program for example, whether or not the whole program can be viewed as a 3D video which is easy to be viewed stereoscopically, before the reproduction of the images of the program is started.

Next, the quality determining unit 206 analyzes the coding-related information output by the decoding unit 202, and determines whether or not the decoded images can be viewed as a 3D video which is easy to be viewed stereoscopically (S902). In the case where the quality determining unit 206 determines that the decoded images can be viewed as a 3D video which is easy to be viewed stereoscopically, the quality determining unit 206 turns off a modification flag and outputs the turned-off modification flag to the screen generating unit 205. In the case where the quality determining unit 206 determines that the decoded images can not be viewed as a 3D video which is easy to be viewed stereoscopically, the quality determining unit 206 turns on a modification flag and outputs the turned-on modification flag to the screen generating unit 205. Step S902 is described in detail later.

Next, the screen generating unit 205 generates an output screen, based on the information obtained from the control unit 204 and the modification flag obtained from the quality determining unit 206 (S903). Step S903 is described in detail later.

First, processes in Steps S306, S307, S309, and S310 are executed.

Next, exemplary processes executed in Step S902 are described in detail with reference to the drawings.

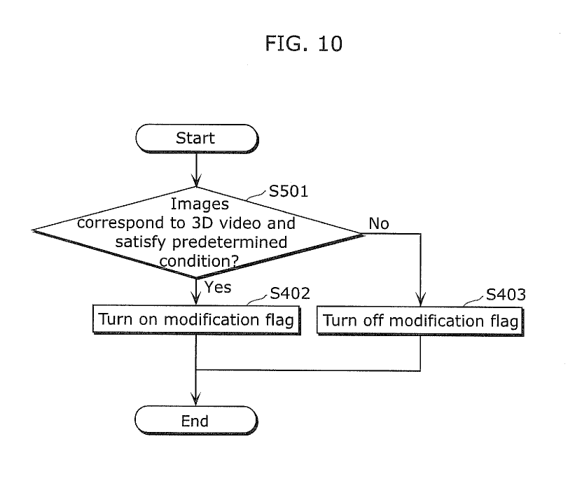

FIG. 10 is a flowchart indicating exemplary processes that the quality determining unit 206 performs to determine whether or not decoded images can be viewed as a 3D video which is easy to be viewed stereoscopically.

Here, operations in Steps S402 and S403 are the same as those in the embodiment. Thus, the same reference signs are assigned thereto, and the same detailed descriptions are not repeated here.

First, the quality determining unit 206 analyzes the coding-related information, and determines whether or not the input stream corresponds to a 3D video and satisfies a predetermined condition (S501).

First, processes in Steps S402, and S403 are executed.

Here, whether or not the input stream corresponds to a 3D video or a 2D video is determined by analyzing the header information of the input stream. For example, in the case where the quality determining unit 206 determines that the input stream includes at least one frame which can be viewed as a part of a 3D video, the quality determining unit 206 determines that the whole video of the input stream is a 3D video. Alternatively, it is possible to count the number of frames which can be viewed as parts of a 3D video, calculate the rate of the number of the frames with respect to the total number of frames of the input stream, and when the number of the frames is equal to or larger than a predetermined threshold, to determine that the whole video of the input stream is a 3D video.

For example, a quantization step used in the coding of the input stream is used as the predetermined condition. More specifically, whether or not the quantization width is equal to or larger than a predetermined first threshold is determined as the predetermined condition. For example, whether or not the average value of the quantization widths of the respective frames of the input stream is equal to or larger than the predetermined first threshold is determined as the predetermined condition. For example, it is possible to make such a determination based on the average value of the quantization widths of I-pictures.

Alternatively, it is possible to use the recording rate of the input stream as the predetermined condition. More specifically, whether or not the recording rate of the input stream is equal to or smaller than a predetermined second threshold is determined to be the predetermined condition. Here, the recording rate is the average bit rate of the input stream, and is calculated based on the data amount and the recording time of the input stream. Alternatively, it is possible to determine the recording rate based on the recording mode.

Next, operations by the screen generating unit 205 are described with reference to the drawings.

In the case where a turned-off modification flag is output, the screen generating unit 205 makes a transition to Step S306 without generating a screen.

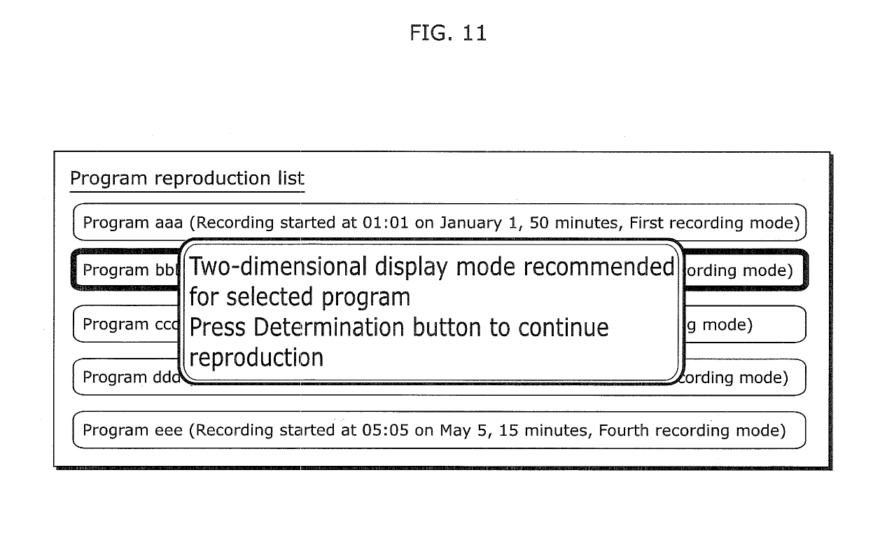

Alternatively, as shown in FIG. 11, for example, in the case where the turned-on modification flag is output, the screen generating unit 205 may add a message recommending that the input signal be displayed according to the two-dimensional mode to the decoded images and outputs the decoded images with the message. In this case, a press of the Determination button starts the reproduction of the 3D video. Here, in the case of displaying the input signal according to the two-dimensional mode upon receiving the message, it is possible to reproduce the input signal as a 2D video by modifying the setting for the recording apparatus 1 to the two-dimensional mode using the remote controller 7.

Furthermore, in the case where the turned-on modification flag is output, the screen generating unit 205 may stop the reproduction of the input signal as the 3D video.

As described above, the video reproducing apparatus according to this variation of the embodiment is intended to obtain coding-related information of an input stream before reproducing decoded images, and determines whether or not the decoded images can be viewed as a 3D video which is easy to be viewed stereoscopically, based on the coding-related information. For example, it is possible to determine, for each program, whether or not the whole program can be viewed as a 3D video which is easy to be viewed stereoscopically, before the reproduction of the images of the program is started. Here, the video reproducing apparatus displays a message recommending the display of the input signal as a 2D video on the screen in the case where the video reproducing apparatus determines that the image signals cannot be viewed safely. In this way, it is possible to reduce eye strain and visually induced motion sickness which are caused when a 3D video with compression distortion is viewed. Furthermore, it is possible to reduce the load on the video reproducing apparatus because it is only necessary for the video reproducing apparatus to make a determination only once before the reproduction of the decoded images is started.

In this variation, the coding-related information of the input stream is obtained immediately before the input stream is reproduced. However, the video reproducing apparatus may be configured to analyze a recorded stream and calculate a modification flag while the video reproducing apparatus is not operated by the user.

### Summary

As described above, the recording apparatus 1 according to the embodiment is a recording apparatus which decodes and outputs coded images for stereoscopic viewing, and includes: a decoding unit 202 configured to decode the obtained coded images for stereoscopic viewing, and output the decoded images for stereoscopic viewing and coding-related information which is used in the coding of the images for stereoscopic viewing and is related to compression distortion which occurs due to the coding; a quality determining unit 206 configured to determine whether the decoded images for stereoscopic viewing should be output as a two-dimensional video or as a three-dimensional video, based on the coding-related information related to the compression distortion; and a screen generating unit 205 configured to output the decoded images for stereoscopic viewing as the two-dimensional video or the three-dimensional video, according to the determination by the quality determining unit.

With this structure, it is possible to determine whether the raw decoded images for stereoscopic viewing should be output as a 3D video or as a 2D video, based on coding-related information. In this way, it is possible to reproduce the decoded images according to the characteristics of the coded images for stereoscopic viewing. For example, in the case where the raw decoded images for stereoscopic viewing are difficult to be viewed, it is possible to reproduce the decoded images as a 2D video by forcibly switching to the 2D images. Therefore, it is possible to provide the recording apparatus 1 which reduces the eye strain of the viewer.

Preferably, the coding-related information is at least one of the quantization widths, the quantization matrices, the quantized parameters, the recording modes, and the recording rates whichever are used in the coding of the images for stereoscopic viewing.

Furthermore, preferably, the quality determining unit 206 determines that the decoded images for stereoscopic viewing should be output as a two-dimensional video when the compression distortions are determined to be larger than the predetermined threshold and determines that the decoded images for stereoscopic viewing should be output as a three-dimensional video when the compression distortion is determined not to be larger than the predetermined threshold, based on the coding-related information.

In this way, it is possible to determine the compression distortion in the decoded images for stereoscopic viewing more accurately. In this way, it is possible to execute switching between the 2D images and the 3D images more appropriately even in the case of forcibly switching to the 2D images.

More preferably, the quality determining unit 206 stores coding-related information for the decoded images for stereoscopic viewing, and the quality determining unit 206 determines whether or not the input signal should be output as a two-dimensional video or a three-dimensional video, based on statistical information obtainable from the stored coding-related information.

In this way, it is possible to determine whether the decoded images for stereoscopic viewing should be output as a 2D video or as a 3D video, based on items of the coding-related information stored in a predetermined past period of time. In this way, it is possible to execute switching between the 2D images and the 3D images more appropriately even in the case of forcibly switching to the 2D images.

More preferably, the recording apparatus 1 further includes a receiving unit 105 which receives a reproduction instruction of coded images for stereoscopic viewing. Upon receiving the reproduction instruction, the quality determining unit 206 of the recording apparatus 1 preferably determines whether the decoded images for stereoscopic viewing should be output as a two-dimensional video or as a three-dimensional video, based on the coding-related information, before the output of the decoded images for stereoscopic viewing is started. The screen generating unit 205 of the recording apparatus 1 preferably outputs the decoded images for stereoscopic viewing as a three-dimensional video or as a two-dimensional video, according to the determination by the quality determining unit 206.

In this way, it is possible to determine and set whether the decoded images for stereoscopic viewing should be output as a 2D video or as a 3D video before the output of the decoded images is actually started. In this case, for example, there is no possibility that currently being reproduced decoded images for stereoscopic viewing are switched between 3D images and 2D images. Thus, the viewer can view the decoded images for stereoscopic viewing displayed according to one of the reproduction modes which is constant from start to end.

More preferably, the receiving unit 105 receives a reproduction instruction indicating whether the coded images for stereoscopic viewing should be output as a two-dimensional video or as a three-dimensional video, the screen generating unit 206 outputs a signal indicating that the decoded images for stereoscopic viewing is output as a two-dimensional video before the decoded images for stereoscopic viewing is output, in the case where the receiving unit 105 receives the reproduction instruction indicating outputting the images for stereoscopic viewing as a 3D video and the quality determining unit 206 determines outputting the decoded images as a two-dimensional video.

In this way, it is possible to notify the switching operation to the viewer when the decoded images for stereoscopic viewing are forcibly switched to the 2D images. In this way, the viewer can clearly recognize the operations by the recording apparatus 1.

More preferably, the quality determining unit 206 detects a scene change based on the decoded images for stereoscopic viewing, and determines whether the decoded images for stereoscopic viewing should be output as a two-dimensional video or as a three-dimensional video based on the coding-related information.

In this way, it is possible to switch between three-dimensional images and two-dimensional images with the timing of a scene change, without switching between the 3D images and the 2D images during the display of the same scene. Thus, the viewer can stably view the same scene of the decoded images for stereoscopic viewing according to the same reproduction mode.

More specifically, the recording apparatus 1 includes the drive device 101, the input and output IF unit 102, the tuner 103, and the like all of which are used to obtain coded images for stereoscopic viewing.

It is to be noted that the present invention can be realized as a video reproducing method including the steps corresponding to the unique units of the above-described recording apparatus 1.

### Other Variations

Although the present invention has been described above based on the exemplary embodiment, but the present invention is not limited to the exemplary embodiment.

For example, in the above embodiment, the tree-dimensional mode or the two-dimensional mode is set based on the coding-related information such as header information of the input stream obtainable in the decoding of the input stream. Here, it is possible to analyze program information of the input stream, and determine whether the program to be recorded is a 3D video program or a 2D video program. Here, the program information includes information indicating that the input stream is a 3D video program, or information indicating that the input stream is a 2D video program. These information items are meta information items assigned in units of a program. An example of such a program information item is an Electronic Program Guide (EPC).

Although a quantization width in the coding-related information of a part of the input stream is used to calculate a modification flag in this embodiment, other methods are also conceivable. For example, it is possible to make such a determination based on the strength setting information of a deblocking filter, the ratio between the number of intra-predicted blocks and the number of inter-predicted blocks, the statistical information of a motion vector, or the like. Furthermore, it is possible to make such a determination by combining these coding-related information items.

In this embodiment, the quality determining unit 206 analyzes the coding-related information in units of a frame (picture), and determines whether the decoded images correspond to a 3D video and satisfy a predetermined condition. However, these processes are exemplary. For example, the quality determining unit 206 may detect a scene change in the decoded images, and determines whether the decoded images correspond to a 3D video and satisfy a predetermined condition.

In this embodiment, when the quality determining unit 206 switches modification flags, the screen generating unit 205 immediately switches from the decoded 3D images to the decoded 2D images and outputs the decoded 2D images. However, it is possible to have a delay time before such switching. For example, the screen generating unit 205 may detect a scene change between decoded images, switch from the decoded 3D images to the decoded 2D images with the timing of the scene change after a turned-off modification flag is turned on, and outputs the decoded 2D images. The screen generating unit 205 may switch from the decoded 2D images to the decoded 3D images with the timing of the scene change after a turned-on modification flag is turned off, and outputs the decoded 3D images. For example, a method for detecting a scene change which is frequently used is a method for making such a determination according to whether or not the SAD between a current frame and the immediately-before frame is equal to or greater than a threshold value.

Although one of the right images and the left images which compose the 3D video are output as a 2D video in this embodiment, it is possible to generate a 2D video from both the right images and the left images by performing signal processing. For example, it is possible to generate a distance image of the images for stereoscopic viewing according to a disparity detection technique, and to generate an image signal at the center of the right and left viewpoints, based on the generated image.

It is also possible to gradually switch from a 3D video to a 2D video over a predetermined period of time, instead of suddenly switching from the 3D video to the 2D video. Likewise, it is also possible to gradually switch from a 2D video to a 3D video over a predetermined period of time. Such gradual switching can be achieved by using a filter or the like.

Furthermore, the present invention can be implemented not only as the video reproducing apparatus in the embodiment, but also as a video signal coding apparatus. The video signal coding apparatus determines whether to code the images as a 3D video or as a 2D video, according to one of the quantization widths determined by the coding unit which compresses and codes the 3D video and the bandwidth of the network for transmitting the coded stream. Examples of specific methods for coding the images as a 2D video include a method for coding only first-view image signals. It is also possible to replace a second-view image with a corresponding first-view image when coding the 3D video.

The modification flag is calculated based on the quantization width in the input stream in this embodiment. However, with the 3D video recording apparatus combined, other methods can be performed. For example, the 3D video recording apparatus determines in advance whether or not the images should be output as a 2D video in the 3D video reproducing apparatus. The result of the determination or parameters such as a quantization width based on which the determination can be made is coded as supplemental information which does not affect the decoded images. Then, the 3D video reproducing apparatus determines whether or not to output the images as the 2D video using the supplemental information.

Program information and a recording condition are presented to the user by generating and displaying a message screen onto a display in this embodiment, but it is also possible to present such program information and a recording condition using sounds.

Alternatively, it is also possible to prepare a 3D safety mode for a video recorder, cause the video recorder to perform operations as in the embodiment when the 3D safety mode is turned on, and cause the recorder to always perform operations which are performed according to a turned-off modification flag when the 3D safety mode is turned off.

The present invention can also be implemented as a video signal reproducing method having the steps corresponding to the unique units of the video reproducing apparatus, as a video signal reproducing integrated circuit including the unique units of the video reproducing apparatus, and as a video signal reproducing program which can realize the video signal reproducing method.

Furthermore, the video signal reproducing program can be distributed via recording media such as Compact Disc-Read Only Memory (CD-ROMs) and communication networks such as the Internet.

Furthermore, the video signal reproducing integrated circuit can also be implemented in the form of an LSI which is a typical integrated circuit. In this case, each of these units may be in plural single-function LSIs, or also may be in one integrated LSI. For example, the functional blocks other than the memory may be integrated into a single LSI. The name used here is LSI, but it may also be called IC, system LSI, super LSI, or ultra LSI depending on the degree of integration.

Moreover, ways to achieve integration are not limited to the LSI, and special circuit or general purpose processor and so forth can also achieve the integration. Field Programmable Gate Array (FPGA) that can be programmed after manufacturing LSI or a reconfigurable processor that allows re-configuration of the connection or configuration of LSI can be used for the same purpose.

Furthermore, when a circuit integration technology for replacing LSIs with new circuits appears in the future with advancement in semiconductor technology and derivative other technologies, the circuit integration technology may be naturally used to integrate functional blocks. For example, application of biotechnology is one such possibility.

Alternatively, it is also good to form, as a separate chip, the unit for storing data among the functional blocks, instead of integrating all the units into the single LSI.

Although only an exemplary embodiment of the present invention has been described in detail above, those skilled in the art will readily appreciate that many modifications are possible in the exemplary embodiment without materially departing from the novel teachings and advantages of the present invention. Accordingly, all such modifications are intended to be included within the scope of the present invention.

### INDUSTRIAL APPLICABILITY

The video reproducing apparatus according to the present invention performs signal processing and outputs image signals of decoded images generated by compressing and decoding a coded stream so that a user can comfortably view the decoded images as a 3D video. Thus, the present invention is applicable to video recorders, video players, video cameras, digital cameras, personal computers, mobile phones with a camera.

What is claimed is:

1. A video reproducing apparatus which decodes coded images for stereoscopic viewing and outputs the decoded images for stereoscopic viewing, said video reproducing apparatus comprising:
a decoding unit configured to decode the coded images for stereoscopic viewing, and output the decoded images for stereoscopic viewing and coding-related information which is used in the coding of the images for stereoscopic viewing and is related to compression distortion which occurs due to the coding;
a quality determining unit configured to determine whether the decoded images for stereoscopic viewing should be output as a two-dimensional video or as a three-dimensional video, based on the coding-related information related to the compression distortion; and
a screen generating unit configured to output the decoded images for stereoscopic viewing as the two-dimensional video or the three-dimensional video, according to the determination by said quality determining unit.

2. The video reproducing apparatus according to claim 1,
wherein the coding-related information is one of a quantization width, a quantized matrix, a quantization parameter, a recording mode, and a recording rate, the one being used in the coding of the images for stereoscopic viewing.

3. The video reproducing apparatus according to claim 1,
wherein said quality determining unit is configured to:
determine that the decoded images for stereoscopic viewing should be output as the two-dimensional video, based on the coding-related information when said quality determining unit determines that the compression distortion is larger than a predetermined threshold; and
determine that the decoded images for stereoscopic viewing should be output as the three-dimensional video based on the coding-related information when said quality determining unit determines that the compression distortion is equal to or smaller than the predetermined threshold.

4. The video reproducing apparatus according to claim 1, further comprising
a storing unit configured to store the coding-related information of the decoded images for stereoscopic viewing,
wherein said quality determining unit is configured to output the decoded images for stereoscopic viewing as the two-dimensional video or the three-dimensional video, based on statistical information obtained from the coding-related information stored in said storing unit.

5. The video reproducing apparatus according to claim 1, further comprising
a receiving unit configured to receive a reproduction instruction for the coded images for stereoscopic viewing,
wherein, upon receiving the reproduction instruction, said quality determining unit is configured to determine, before the output of the decoded images for stereoscopic viewing is started, whether the decoded images for stereoscopic viewing should be output as the two-dimensional video or as the three-dimensional video, based on the coding-related information, and
said screen generating unit is configured to output the decoded images for stereoscopic viewing as the two-dimensional video or as the three-dimensional video according to the determination by said quality determining unit.

6. The video reproducing apparatus according to claim 5,
wherein said receiving unit is configured to receive the reproduction instruction on whether the coded images for stereoscopic viewing should be output as the two-dimensional video or as the three-dimensional video, and
when said receiving unit receives the reproduction instruction indicating reproduction of the coded images for stereoscopic viewing as the three-dimensional video and said quality determining unit determines that the decoded images for stereoscopic viewing should be output as the two-dimensional video, said screen generating unit is configured to output a signal indicating output of the decoded images for stereoscopic viewing as the two-dimensional video before outputting the decoded images for stereoscopic viewing.

7. The video reproducing apparatus according to claim 1,
wherein said quality determining unit is configured to detect a scene change, based on the decoded images for stereoscopic viewing, and determine whether the decoded images for stereoscopic viewing should be output as the two-dimensional video or as the three-dimensional video, based on the coding-related information upon detecting the scene change.

8. The video reproducing apparatus according to claim 1, further comprising
an obtaining unit configured to obtain the coded images for stereoscopic viewing.

9. A video reproducing method of decoding coded images for stereoscopic viewing and outputting the decoded images for stereoscopic viewing, said video reproducing method comprising:
decoding the coded images for stereoscopic viewing, and outputting the decoded images for stereoscopic viewing and coding-related information which is used in the coding of the images for stereoscopic viewing and is related to compression distortion which occurs due to the coding;
determining whether the decoded images for stereoscopic viewing should be output as a two-dimensional video or as a three-dimensional video, based on the coding-related information related to the compression distortion; and
outputting the decoded images for stereoscopic viewing as the two-dimensional video or the three-dimensional video, according to the determination in said determining.
